(19) United States
(12) Patent Application Publication
(10) Pub. No.: US 2005/0120164 A1
(43) Pub. Date: Jun. 2, 2005

(54) Pen drive for wireless wide bandwidth local network

(75) Inventors: Cheng-Hui Yang, Chutung Town (TW); Chih-Jen Hsu, Chutung Town (TW)

Correspondence Address: BACON & THOMAS, PLLC, 625 SLATERS LANE, FOURTH FLOOR, ALEXANDRIA, VA, 22314, US

(73) Assignee: Phison Electronics Corp., Chutung Town (TW)

(21) Appl. No.: 10/724,066

(22) Filed: Dec. 1, 2003

(51) Int. Cl. G06F 12/00

(52) U.S. Cl. 711/103; 711/165; 711/203

(57) ABSTRACT

A pen drive is described. The pen drive has a control chip, a flash memory controller, at least one flash memory and a USB, a wireless wide bandwidth local network module and an antenna module. The pen drive can connect to a host equipped with a USB, such as, a notebook computer equipped with USB. This allows the host not only to save or retrieve data (or command) to or from the flash memory, but also allows the use of wireless wide bandwidth local network module to link to a wireless wide bandwidth local network. Thus, the pen drive can store data of the host, as well as allows the host to link to the wireless network allowing the user to enjoy the convenience and value added features.

### BACKGROUND OF THE INVENTION

1. The Field of the Invention

The present invention relates to a pen drive for connecting to a wireless wide bandwidth local network, and more particularly relates to a pen drive for not only storing data of a host but also for enabling the host to link to a wireless network.

2. Description of the Related Art

Presently, the new device, pen drive, enables a user to save data into an external memory device and also as well read data stored therein, and also has the advantage of compactness and portability providing substantial convenience. The advantages of the pen drive have conquered the most of the conventional storage devices, for example, hard disk drive, and that is why the pen drive has become the most popular storage device.

But certain limitations has set the boundary for the pen drive for storing data of the computer or for the computer to read the data stored in the flash memory only. In other words, the drive is in idle state when the data transmission do not occur between the computer and the drive, and therefore it is a kind of waste of valuable resource, especially for those users who seldom need data transmission.

Therefore, a storage device, which has functions other than just connecting to the computer, can substantially be more valuable for the users.

### SUMMARY OF THE INVENTION

Accordingly, in the view of the foregoing, the present inventor makes a detailed study of related art to evaluate and consider, and uses years of accumulated experience in this field, and through several experiments, to create a new pen drive. The present invention provides an innovated cost effective pen drive for connecting to a wireless wide bandwidth local network.

According to an aspect of the present invention, the pen drive comprises a control chip, a flash memory controller, at least one flash memory and a USB, a wireless wide bandwidth local network module and an antenna module. The pen drive can connect to a host equipped with a USB, such as a notebook computer, through its own USB. This allows the host to not only save or retrieve data (or command) to or from the flash memory, but also allows the use of wireless wide bandwidth local network module to link to a wireless wide bandwidth local network. Thus, the pen drive can store data of the host, as well as allows the host to link to the wireless network allowing the user to enjoy the convenience and value added features.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram of a pen drive according to a preferred embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

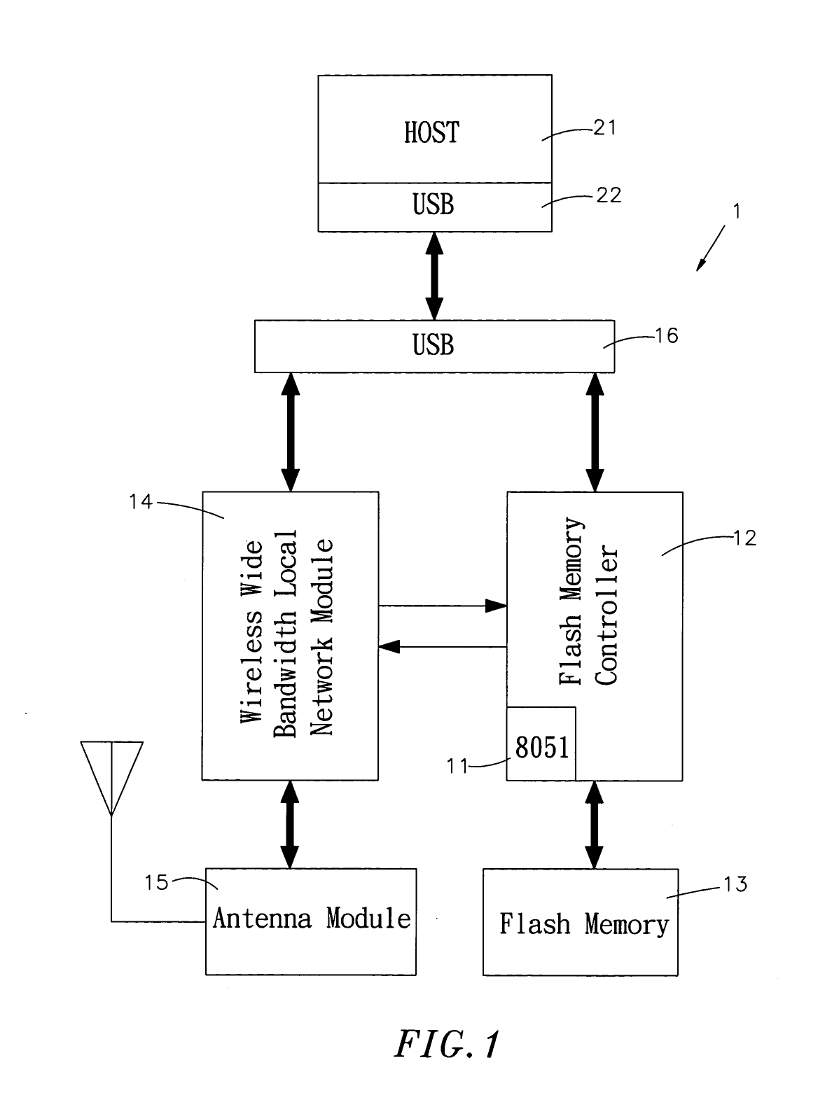

Referring to FIG. 1, is a block diagram of a pen drive according to a preferred embodiment of the present invention is shown. The pen drive 1 for connecting to a wireless wide bandwidth local network comprises a control chip 11, a flash memory controller 12, at least one flash memory 13, a wireless wide bandwidth local network module 14, an antenna module 15 and a USB 16. The control chip 11 is for controlling the command and figures between the pen drive 1 and a host 21, for example, but not limited to, a notebook computer or a PDA, also for controlling the figures of the array (or module) of the flash memory 13 and the figures (for example, internet protocol flow) required for the initialization of the wireless wide bandwidth local network module 14. The control chip 11 can control the flash memory controller 12 to enable the host 21 to save/retrieve data (or command) to/from the flash memory 13. The wireless wide bandwidth local network module 14 can be electrically connected to the host 21 through the USB 16, and also to process the wireless network protocol, for example, WAP, to convert the digital protocol data signal into the analogue protocol data signal. The antenna module 15 is for receiving (or transmitting) the analogue protocol data signal. And furthermore, the flash memory 13 contains the initialization program for the wireless wide bandwidth local network module 14.

Referring to FIG. 1 again, when the pen drive 1 connects to the host 21 equipped with a USB 22 through its own USB 16, the host 21 is not only capable of saving/retrieving data (or command) to/from the flash memory 13 of the pen drive 1, but also allows the use of the wireless wide bandwidth local network module 14 and the antenna module 15 of the pen drive 1 to link to the wireless wide bandwidth local network. Thus the pen drive 1 can save/retrieve data of the host 21, and also allows the host 21 to link to the wireless wide bandwidth local network.

In the present invention, the control chip 11 can be a 8051 single chip, and has a driving program burned or recorded therein, so when the pen drive 1 connects to the host 21, the control chip 11 can control the flash memory controller 12 according to the commands of the host 21 for saving/retrieving data (or command) to/from the flash memory 13, and also to manage the figures (for example, internet protocol flow) required for the initialization of the wireless wide bandwidth local network module 14.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A pen drive for connecting to a wireless wide bandwidth local network, comprising:
a USB;
at least one flash memory, having an initialization program for a wireless wide bandwidth local network module;
a flash memory controller;
a control chip, for controlling commands and figures between said pen drive and a host, and also for managing array of said flash memory and figures of module, and also for controlling figures required for the initialization of said wireless wide bandwidth local network module, said control chip can control said flash memory controller to enable said host to save/retrieve data or command to/from said flash memory;
a wireless wide bandwidth local network module, electrically connected to said host by said USB, for enabling to process a wireless network protocol to convert a digital protocol data signal into an analogue protocol data signal; and
an antenna module, for receiving or transmitting said analogue protocol data signal, wherein when said drive connects to said host through said USB, said host saves/retrieves data or command to/from said flash memory and also links to said wireless wide bandwidth local network through said wireless wide bandwidth local network module and said antenna module.

2. The pen drive for connecting to a wireless wide bandwidth local network according to claim 1, wherein said host is a notebook computer.

3. The pen drive for connecting to a wireless wide bandwidth local network according to claim 1, wherein said wireless network protocol is a WAP.

4. The pen drive for connecting to a wireless wide bandwidth local network according to claim 1, wherein said control chip is a 8051 single chip, having a driving program burned or recorded therein, so that when the pen drive connects to the host, the control chip controls the flash memory controller according to the command of the host to save/retrieve data (or command) to/from the flash memory.
